(19) United States
(12) Patent Application Publication
(10) Pub. No.: US 2014/0025427 A1
(43) Pub. Date: Jan. 23, 2014

(54) INFERRING AND SUGGESTING ATTRIBUTE VALUES FOR A SOCIAL NETWORKING SERVICE

(71) Applicants: Mathieu Bastian, San Francisco, CA (US); Peter N. Skomoroch, Sunnyvale, CA (US); Matthew T. Hayes, Milipitas, CA (US)

(72) Inventors: Mathieu Bastian, San Francisco, CA (US); Peter N. Skomoroch, Sunnyvale, CA (US); Matthew T. Hayes, Milipitas, CA (US)

(73) Assignee: Linkedln Corporation, Mountain View, CA (US)

(21) Appl. No.: 13/629,241

(22) Filed: Sep. 27, 2012

Related U.S. Application Data
(60) Provisional application No. 61/672,613, filed on Jul. 17, 2012.

(51) Int. Cl. G06Q 30/02; G06Q 50/00

(52) U.S. Cl. CPC G06Q 30/0201; G06Q 50/01
USPC 705/7.29

(57) ABSTRACT

Disclosed in some examples is a method of inferring one or more attribute values of a member of a social networking service by collecting a plurality of attribute values associated with attributes of a plurality of members of a social networking service, the plurality of attribute values including member profile information; and inferring one or more attribute values regarding a particular member in the plurality of members based upon the collected plurality of attribute values and a plurality of collected attribute values of the particular member.

### CLAIM OF PRIORITY

This patent application claims the benefit of priority, under 35 U.S.C. Section 119(e), to U.S. Provisional Patent Application Ser. No. 61/672,613, entitled “INFERRING AND SUGGESTING ATTRIBUTE VALUES FOR A SOCIAL NETWORKING SERVICE,” filed on Jul. 17, 2012, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright LinkedIn, All Rights Reserved.

### BACKGROUND

A social networking service is a computer or web-based application that enables users to establish links or connections with persons for the purpose of sharing information with one another. Some social networks aim to enable friends and family to communicate with one another, while others are specifically directed to business users with a goal of enabling the sharing of business information.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a method of inferring an attribute value according to some examples of the present disclosure.

FIG. 2 shows a probability matrix according to some examples of the present disclosure.

FIG. 3 shows a number of probability matrices according to some examples of the present disclosure.

FIG. 4 shows a screenshot of a recommendation page according to some examples of the present disclosure.

FIG. 5 shows a schematic of a system for providing a social networking service and a recommendation service according to some examples of the present disclosure.

FIG. 6 shows a schematic of a machine according to some examples of the present disclosure.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business networking service. A social networking service is an online service, platform or site that allows members to build or reflect social networks or social relations among members. Typically, members construct profiles, which may include personal information such as name, contact information, employment information, photographs, personal messages, status information, links to web-related content, blogs, and so on. Typically, only a portion of a members profile may be viewed by the general public, and/or other members.

The social networking site allows members to identify, and establish links or connections with other members in order to build or reflect social networks or social relations among members. For instance, in the context of a business networking service (a type of social networking service), a person may establish a link or connection with his or her business contacts, including work colleagues, clients, customers, and so on. With a social networking service, a person may establish links or connections with his or her friends and family. A connection is generally formed using an invitation process in which one member “invites” a second member to form a link. The second member than has the option of accepting or declining the invitation.

In general, a connection or link represents or is otherwise associated with an information access privilege, such that a first person who has established a connection with a second person is, via the establishment of that connection, authorizing the second person to view or access non-publicly available portions of their profiles. Of course, depending on the particular implementation of the business/social networking service, the nature and type of the information that may be shared, as well as the granularity with which the access privileges may be defined to protect certain types of data may vary greatly.

Social networks may also provide various services to their members. One example such service is the formation of skill communities through the identification of member skills based upon information in their profiles. The formation and use of such skill communities is described in U.S. patent application Ser. No. 13/357,171 filed on Jan. 24, 2012 to Skomoroch et. al and entitled “SKILL EXTRACTION SYSTEM,” which is hereby incorporated by reference in its entirety, U.S. patent application Ser. No. 13/357,302 filed on Jan. 24, 2012 to Skomoroch et. al. and entitled “SKILL RANKING SYSTEM,” which is hereby incorporated by reference in its entirety, and U.S. patent application Ser. No. 13/357,360 filed on Jan. 24, 2012 to Skomoroch et. al. and entitled “SKILL CUSTOMIZATION SYSTEM,” which is hereby incorporated by reference in its entirety.

In an effort to enhance the social networking experience by providing services tailored to members, the social networking service may make inferences about the member from information the social networking service has about the member (e.g., member profile items, activities on the site, or the like) and aggregate information about the member population of the social networking service. These inferences may then be used to provide custom features and enhancements to the member. For example, the system may suggest one or more skills that the member may possess for addition to the member's profile. In other examples, the system may enhance a search capability using these inferences. Thus for example a search for members who are associated with venture capital might return those members who explicitly list venture capital in their member profiles, but also those members that the system inferred were interested or associated with venture capital.

Disclosed in some examples are methods, systems and machine readable media which may infer various attributes about members based upon information the system has regarding the member (e.g., information in the user profile, activities of the member, or the like) and aggregate information about the member population of the social networking service. In some examples, the data in a member's profile may be compared with statistical probability data calculated from other member's profiles to generate a recommendation for that member. So, for example, if members with attributes A and B also frequently have attribute C, a member with just A and B may be inferred to have attribute C. In some examples, the system may calculate a probability matrix for each individual attribute which calculates, given a member's particular attribute values for that attribute, the probability that the member has an attribute value of interest. These individual probability vectors may then be normalized, weighted, and combined to yield a final probability. This final probability describes the probability that the member has that particular attribute value of interest. If the probability that the member possesses a given attribute value is high enough, the system may infer that the member possesses the given attribute value. For ease of description, an attribute comprises a type or category of information whereas an attribute value comprises the actual value of that attribute. For example, an attribute may be a company name, a geographical location, an educational institution, or the like. Actual attribute values include actual company names (e.g., LinkedIn), actual geographical locations (e.g., San Jose Calif.), and actual educational institutions (e.g., Harvard).

One example application is to suggest skills for members. For example, the system may determine that members who work at certain companies may have a high probability of having particular skills. The system may then use that information to suggest those particular skills to members who work at that company. In some examples, the system may use multiple attribute values of various attributes the system knows about a member (e.g., member profile data, interaction data, or the like) to generate a recommendation by generating a composite probability that a member may possess a certain skill based upon the individual probabilities for each attribute value. These probabilities may be weighted, normalized, and/or combined by Bayesian rules to generate a composite probability which describes a probability that a particular member possesses a particular skill.

While the methods and systems herein described are shown for one particular embodiment—suggested skills—the disclosure is not limited to suggestion of skills, but is broadly applicable to any applications which involve inferring attribute values regarding members from information the social networking service knows about its members. For example, the methods of the present invention may be used to search for members not only based on explicit information in their member profiles, but also based on attribute values which are inferred by the system. In other examples, the system may utilize the inferences to serve tailored advertisements to the member. For example, the system may infer product preferences and desires based upon information the social networking service knows about its members. In still other examples, customized news or other information may be delivered to the member based on inferred news interests. The process may suggest one or more groups provided by the social networking service for a member to join. These groups link individuals with common interests. Likewise, one or more member profile attribute changes or additions may be suggested. For example, the system may infer from education and work experience that a member is involved in a particular industry and suggest that the member add that industry to their profile. In other examples, the system may provide suggested connections. These suggested connections may be based upon common interests (which may be inferred or explicit), or may be based upon inferences based upon other connections of the user (e.g., if people who are connected with Mary have a high probability of being connected with John, then suggest John as a connection to a member who is connected with Mary but not already connected with John.)

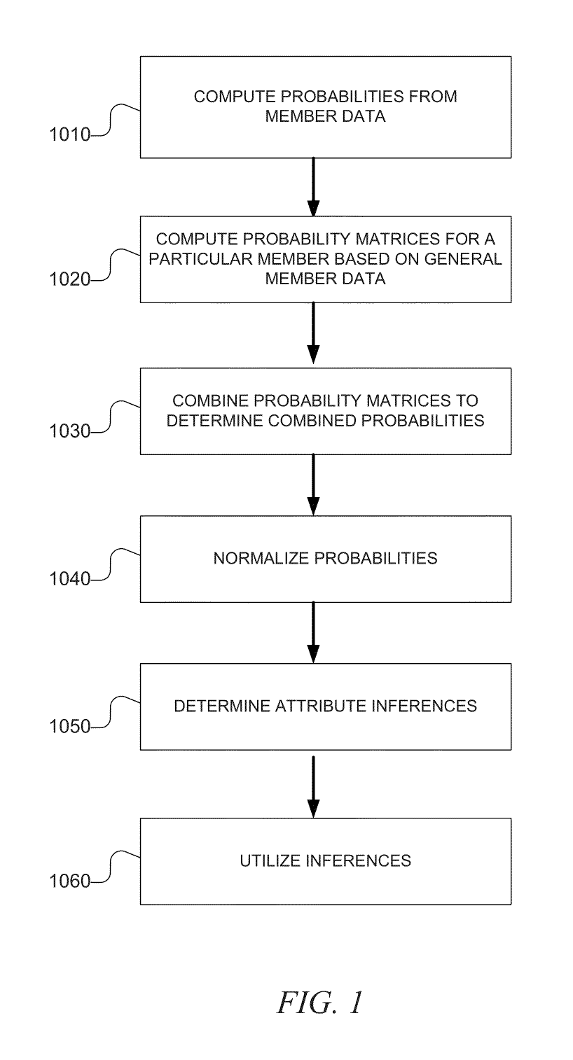

Turning now to FIG. 1 one example method of generating inferred attributes for members is shown. At operation 1010 information the social network knows about a member (including information from the member's profile and member activities) may be processed to create probability estimations that describe the probability that for any given value of a particular member attribute that the member has any other given value of the same, or different member attribute.

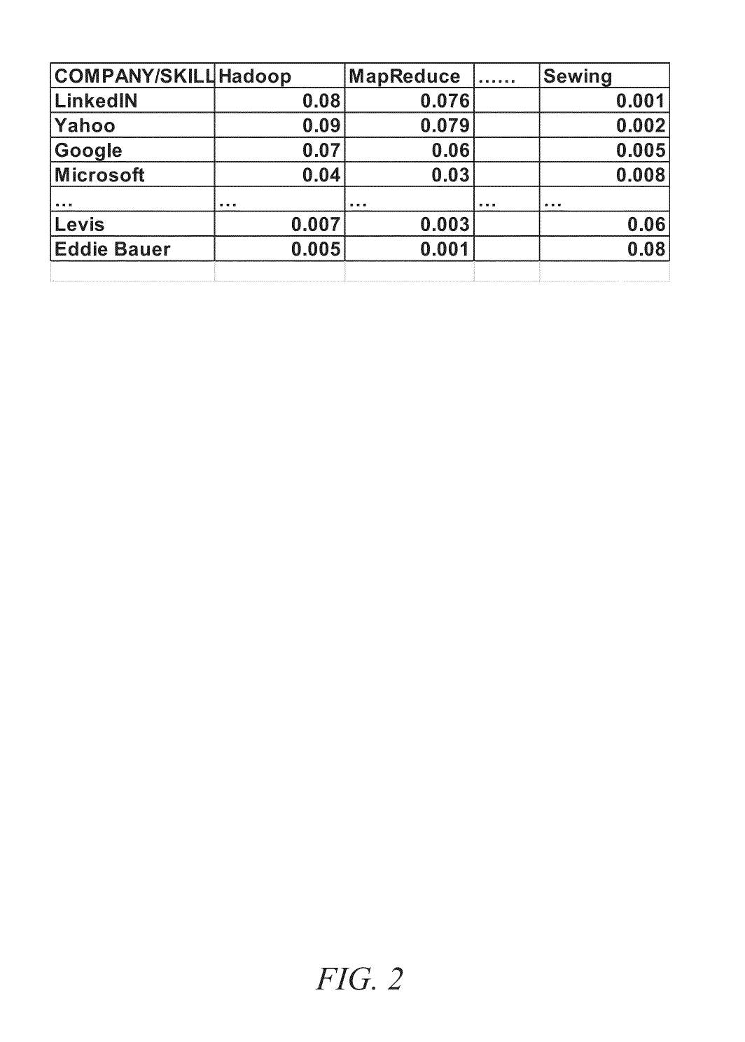

FIG. 2 shows an example of a probability estimation that shows the probabilities of possessing a given skill based upon the particular company listed in a member's profile. The company may be the company that a member works for, or used to work for. Shown are rows of attribute values (e.g., LinkedIn, Yahoo, Google, Microsoft, Levis, Eddie Bauer) representing various companies that members have reported working for. Each element of the matrix has an associated probability which describes the probability that a member reporting that he or she works for that company (or had worked for that company), is associated with a second member attribute value—in this case that the member possesses one of the listed skills (e.g., Hadoop, MapReduce, Sewing). For example, a member who reports that they work at LinkedIn has a 0.08 probability that they know (or possess) a skill dealing with Hadoop and a very slight probability of having a sewing skill. Likewise, a worker at a garment company such as Levis has a very low probability of knowing Hadoop (0.007), but a higher probability of knowing how to sew (0.06). In some examples, the probabilities given are never set to zero in order to allow for the possibility of recommending an unlikely skill which may turn out to be accurate (e.g., a member with a particle physics skill who works at a fast food restaurant).

Applicable member attributes which may be used to infer attribute values, or may be inferred from the system may include any information the social networking service is aware of with respect to its members. This may include both implicit and explicit information. Implicit information includes things like searches, clicks, browsing activity, articles read, product usage, or the like. Implicit information may provide a clue that a user is interested in something, but is not an express or certain expression of interest. Explicit information may be things like following a company, liking something, sharing something, tweeting something, adding a skill to the member's profile, information in the member's profile, or the like. Explicit information includes explicit actions or information offered by a member to expressly indicate an interest in something. Various specific examples include industry affiliation, job titles, company affiliations, specialties, current skills which are associated with the member, groups the member belongs to, connections the member has made, functional areas the member belongs to, field of study the member has reported, geographical location (work and/or home), degrees reported, schools attended, projects worked on, status updates, search history, gender, age, links and articles shared, seniority, discussions participated in, site browsing activity, recommendations, endorsements, or the like.

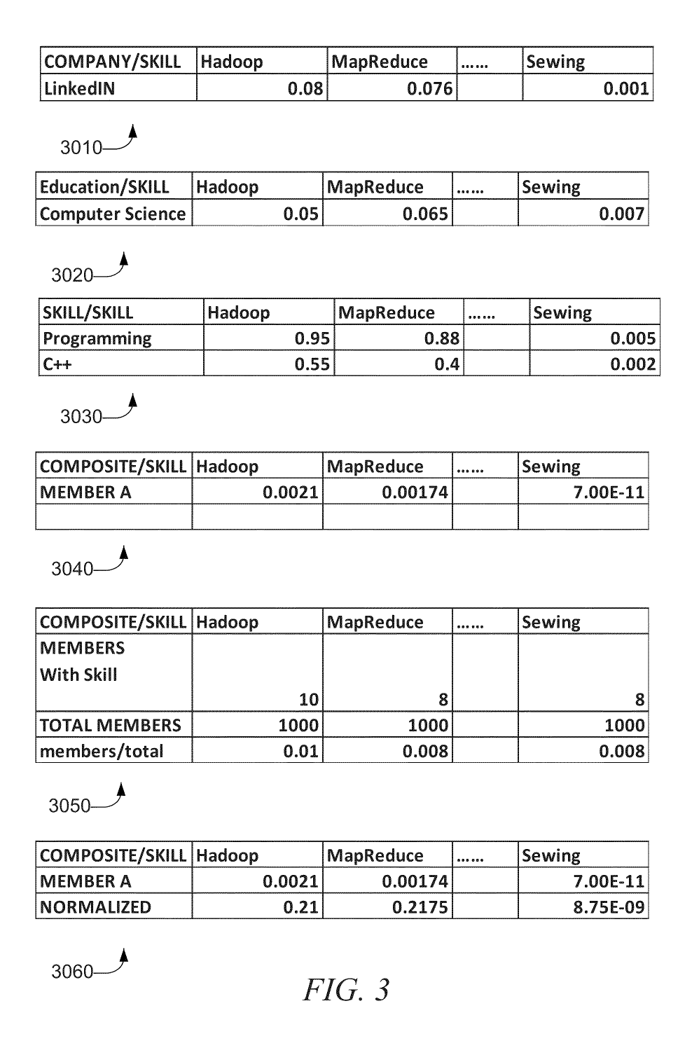

Turning back to FIG. 1, once the probabilities are computed from the general member data, a recommendation may be made for a particular member by utilizing the computed probability matrices and the attribute values known for a particular member to compute a set of probability matrices for a particular member at operation 1020. FIG. 3 shows three matrices 3010, 3020, and 3030 for three separate member attributes (company, education, and other skills) and the associated probabilities that given the attribute values for the attribute for this particular member (in this example the member works at LinkedIn, has a computer science educational background, and lists programming and C++ as skills) that the particular member has one of the skills identified by the system.

At operation 1030, the probabilities of these matrices may then be multiplied to produce a composite vector 3040. In this example, the particular member has a 0.0021 probability for having a Hadoop skill, a 0.00174 probability for having a MapReduce skill and only a slim chance (7×10⁻¹¹) at having a sewing skill. While the examples herein multiplied the probabilities to produce a combined probability, in other examples, other methods may be used. For example, to take into account the fact that different attributes may have different impacts on the total probabilities (e.g., inferences based on other, related skills, may be stronger signals that a member has a particular skill than other, weaker, attributes) each probability vector may be weighted Differently when combining them.

Turning back to FIG. 1, after the combined probability vector is computed for a particular member, the probabilities may be normalized at operation 1040. Normalization in this context refers to division of data by a common variable in order to negate that variable's effect on the data, thus allowing underlying characteristics of the data sets to be compared: e.g., this allows data on different scales to be compared, by bringing them to a common scale. In some examples, the probabilities can be normalized by the total number of members who are associated with that attribute value divided by the total number of members of the social networking service. Thus for example, there may be 1000 total members and ten may have Hadoop as a skill, the Hadoop skill for the member would be divided by 0.01 ( 10/1000) to get a normalized result. In the example in FIG. 3, this produces a normalized probability of 0.21. FIG. 3 shows an example normalization matrix 3050 and a normalized result at 3060.

Turning back to FIG. 1, after the probabilities are normalized, the list of inferred attributes may be determined at operation 1050. In some examples, this may be done based upon a threshold value. Thus any attribute value (e.g., skill) with a probability of being associated with that user that is above a threshold probability may be inferred to be associated with the member. In other examples, a threshold percentage of the top probabilities may be utilized. Thus the threshold may be ten percent, and thus the top ten percent (based on probability of being associated with the member) may be inferred. In still other examples, other attributes of the profile may be used to give the system some measure of confidence in the recommendations. Thus for example in the skill inference examples, a rare skill may show up as a statistically significant probability of being associated with a member, however, due to the rarity of the skill, some additional measure of confidence may be required in order to infer the skill. In some examples, the system may calculate a confidence score for one or more of the skills which reflects a confidence of the system in its recommendations. The confidence score may be based on values of particular member attributes. For example, the system may be confident in inferring the rare skill if it is able to determine that one or more connections of the member possess the rare skill or that the member belongs to one or more groups associated with the rare skill. This confidence score may be based upon connections, groups, or the like. In yet other examples, this confidence score may be integrated into the probability calculations by increasing a weight given to one or more of the profile attributes. Thus, for example, when determining that a user belongs to a group dedicated to a particular skill, the probability contribution for that particular profile attribute to the combined probability vector may be increased.

Turning back to FIG. 1, once the list of skills which are to be inferred is determined, the inferences may be utilized at operation 1060. In some examples, the inferences may be utilized by recommending that the user adopt the inferred attribute explicitly to their profiles (e.g., recommending skills to the member). These recommendations may be accessible by certain user actions such as visiting a specific page on the social networking service dedicated to providing the recommendations. In other examples, the recommendations may be actively delivered to users by sending them in emails, text messages, pop-ups on various pages of the social networking service, presentation as part of other pages on the social networking service and the like. The presentation may contain one or more buttons which may allow a user to explicitly adopt the attribute if the user desires. Additionally, there may be a button for telling the system that it was wrong and the user is not associated (or interested) to the inferred attribute value. In some examples, this feedback may be utilized in adjustments made to the inference calculations. For example, the probability of having the recommended skill based upon the given one or more attribute values associated with the member may be increased by the explicit adoption of that skill by a member. In other examples, if the user declines to explicitly adopt the inferred attribute, the probabilities may be adjusted downward to reflect a decreased probability. In this way, user feedback on the system is used to fine-tune the inferences that the system generates.

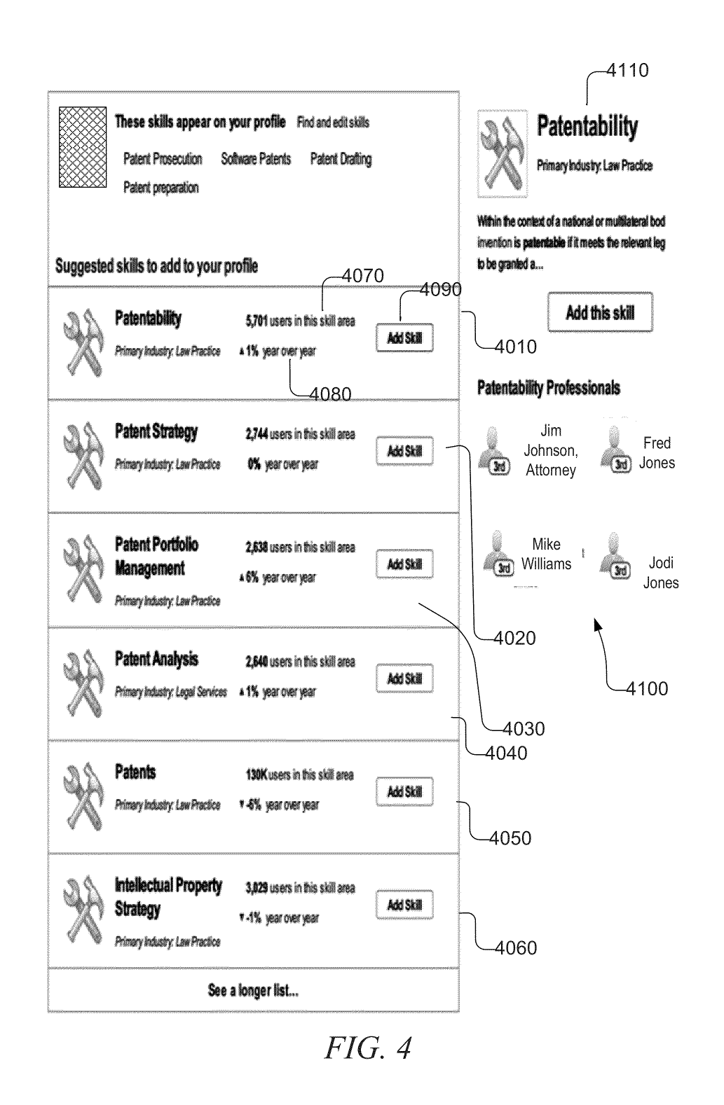

FIG. 4 shows an example screen shot showing a skill recommendation page that may be used to present skill recommendations to members. Shown are skill recommendations 4010, 4020, 4030, 4040, 4050, 4060. Also shown for each skill recommendation is the number of users in that particular skill area 4070, a trend indicator for the particular skill which details the change in the number of members who report having that skill 4080, and a button to press to add a particular skill 4090. On the right hand side a number of members who have a particular skill may be displayed 4100 along with a description of the top recommended skill 4110.

In other examples, the inferences may be utilized in other ways. For example, the system may store the inference in the member's profile (these inferences may be visible or invisible to the member) and use it to deliver more accurate search results, advertising, or the like. Feedback mechanisms may also be incorporated into these methods of utilization as well. For example, the system may track conversion rates, click through rates, or other advertising metrics for advertising delivered to members. If these metrics indicate that the advertisement is performing worse than expected and the advertisement was delivered based on an inferred attribute, the system may determine that the inference was not accurate and adjust the probabilities accordingly by making that particular attribute value combination less likely to generate the particular inference. Likewise, if a member is included in a search result as a result of an inferred attribute and yet that member's profile is not viewed as a result of that search, the system may determine that the inference was not accurate and adjust the probabilities accordingly by making that particular attribute value combination less likely to generate the particular inference.

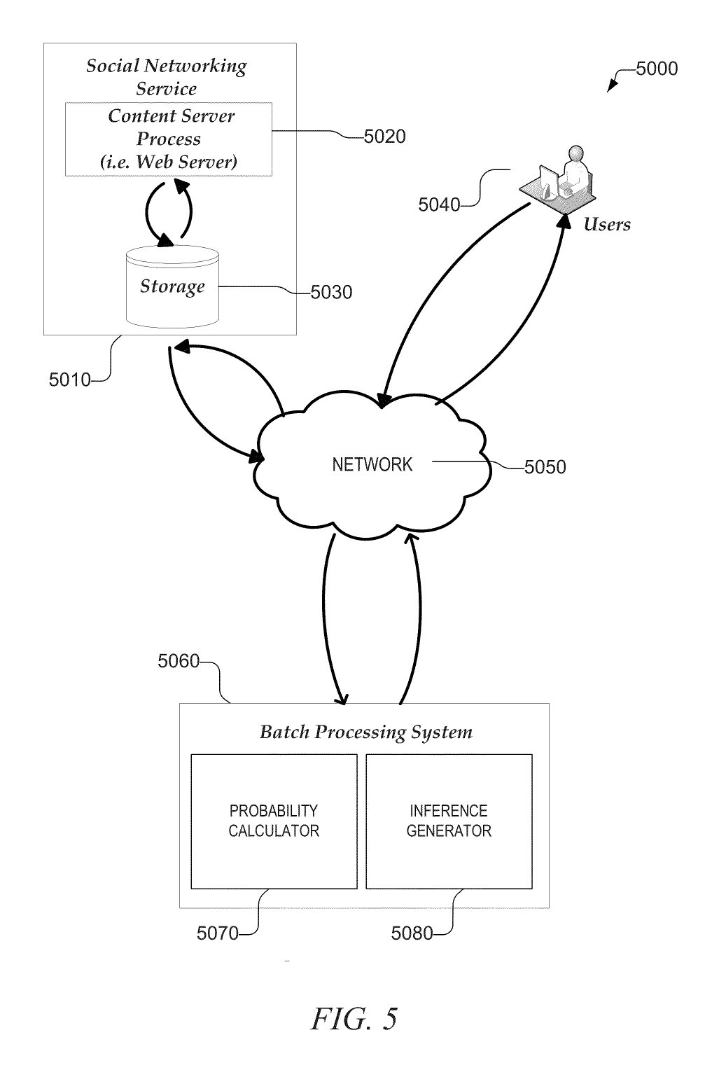

FIG. 5 shows an example system 5000 for providing a social networking service and for recommending various profile attribute values (e.g., skills, or other attributes) based upon other information in a member's profile. Social networking service 5010 may contain a content server process 5020. Content server process 5020 may communicate with storage 5030 and may communicate with one or more users 5040 through a network 5050. Content server process 5020 may be responsible for the retrieval, presentation, and maintenance of member profiles stored in storage 5030. Content server process 5020 in one example may include or be a web server that fetches or creates internet web pages. Web pages may be or include Hyper Text Markup Language (HTML), eXtensible Markup Language (XML), JavaScript, or the like. The web pages may include portions of, or all of, a member profile at the request of users 5040.

Users 5040 may include one or more members, prospective members, or other users of the social networking service 5040. Users 5040 access social networking service 5010 using a computer system through a network 5050. The network may be any means of enabling the social networking service 5010 to communicate data with users 5040. Example networks 5050 may be or include portions of: the Internet, a Local Area Network (LAN), a Wide Area Network (WAN), wireless network (such as a wireless network based upon an IEEE 802.11 family of standards), a Metropolitan Area Network (MAN), a cellular network, or the like.

Batch processing system 5060 may be a computing entity which is capable of data processing operations either serially or in parallel. In some examples, batch processing system 5060 may be a single computing system, but in other examples, batch processing system 5060 may be a series of computers setup to process data in parallel. In yet other examples, batch processing system 5060 may be a part of social networking system 5010.

Batch processing system 5060 may include a probability calculator module 5070 which may receive member information (e.g., member profiles, member activity information, or the like) from the storage 5030 and calculate one or more probability matrices. The probability matrices may be stored in storage 5030, or in a storage device local to batch processing system 5060, or some other storage device. The probability calculator module 5070 may also compute the normalization matrices based on the member data. Batch processing system 5060 may also include an inference generator 5080 which may compute an inference for an individual member based upon the probability matrices and the normalization vectors. Once inferences have been made they may be passed back to the content server process 5020 which may store the inferences in storage 5030 (e.g., as part of the member's profile). When a member 5040 utilizes the social networking service 5010, the content server process 5020 may deliver the inferences as recommendations to the user 5040 as part of one or more of the web pages that comprise the interface of the social networking service. In other examples, the recommendation may be actively delivered to the member in the form of email, text message, or some other notification. In still other examples, the content server process 5020 may utilize the inferences in conducting searches of member information, advertising delivery, news delivery, or the like.

While users 5040, social networking service 5010 and batch processing system 5060 are shown communicating through the same network 5050, social networking service 5010 may communicate with user 5040 through a separate network, or a separate part of network 5050 than what social networking service 5010 uses to communicate with batch processing system 5060.

In some examples, certain aspects of the present disclosure may be done in parallel using a batch processing system (such as batch processing system 5060) over a distributed computer system. In some examples, this distributed computer system may be managed by Apache Hadoop, which is a software framework that supports data intensive distributed applications developed by the Apache Software Foundation, Inc. In some examples, certain aspects of the present disclosure may be implemented by the MapReduce software method which is a framework for processing huge datasets on distributable problems using a large number of computers (or nodes) which are referred to as a cluster. MapReduce is described in U.S. Pat. No. 7,650,331 issued to Dean, et. al. and assigned to Google Inc., of Mountain View, Calif., which is hereby incorporated by reference in its entirety. In MapReduce, there are two phases: the map phase and the reduce phase. In the “map” phase, “chunks” of data are assigned to different servers which then process the data according to a defined algorithm and return a result. The servers may break up the data into even smaller chunks and assign each smaller chunk to a map process running on the server, where many map functions may execute on a single server. The results from all the map processes are then aggregated according to a predefined process in the “reduce” phase.

These examples can be combined in any permutation or combination. This overview is intended to provide an overview of subject matter of the present patent application. It is not intended to provide an exclusive or exhaustive explanation of the invention. The detailed description is included to provide further information about the present patent application.

### Modules, Components and Logic

Certain embodiments are described herein as including logic or a number of components, modules, or mechanisms. Modules or components may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors, including processor 8010, may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Implementation

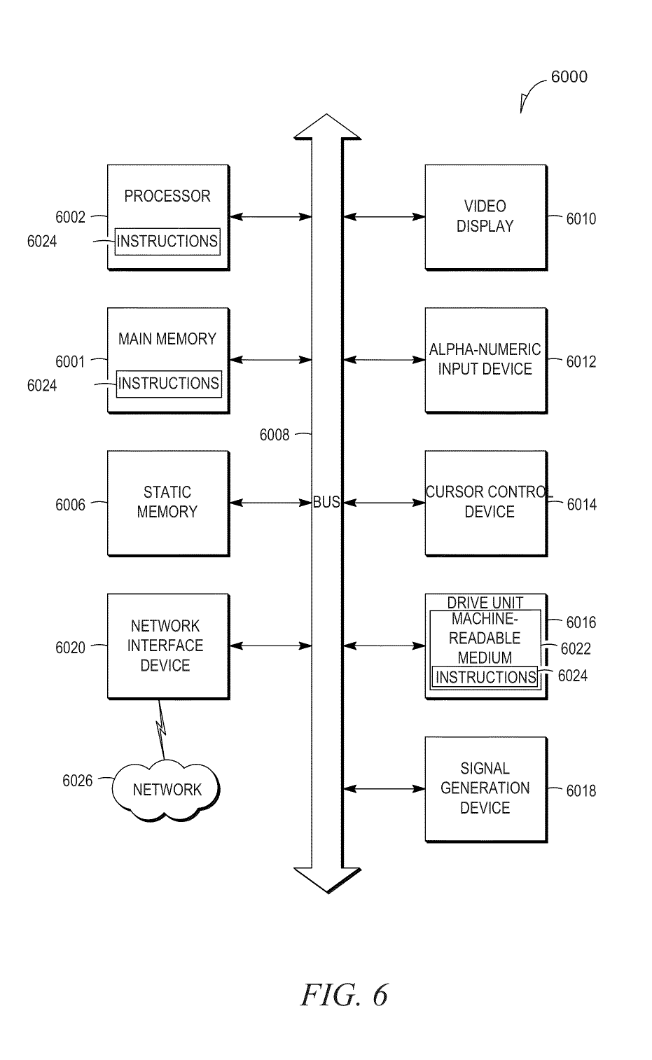

FIG. 6 shows a diagrammatic representation of a machine in the example form of a computer system 6000 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments may also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 6000 includes a processor 6002 (e.g., a Central Processing Unit (CPU), a Graphics Processing Unit (GPU) or both), a main memory 6001 and a static memory 6006, which communicate with each other via a bus 6008. The computer system 6000 may further include a video display unit 6010 (e.g., a Liquid Crystal Display (LCD) or a Cathode Ray Tube (CRT)). The computer system 6000 also includes an alphanumeric input device 6012 (e.g., a keyboard), a User Interface (UI) controller 6014 (e.g., a mouse), a disk drive unit 6016, a signal generation device 6018 (e.g., a speaker) and a network interface device 6020 (e.g., a transmitter).

The disk drive unit 6016 includes a machine-readable medium 6022 on which is stored one or more sets of instructions 6024 and data structures (e.g., software) embodying or used by any one or more of the methodologies or functions illustrated herein. The software may also reside, completely or at least partially, within the main memory 6001 and/or within the processor 6002 during execution thereof by the computer system 6000, with the main memory 6001 and the processor 6002 also constituting machine-readable media.

The instructions 6024 may further be transmitted or received over a network 6026 via the network interface device 6020 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

### ADDITIONAL NOTES AND EXAMPLES

### Example 1

Disclosed in some examples is a method of inferring one or more attribute values of a member of a social networking service, the method including collecting a plurality of attribute values associated with a plurality of attributes of a plurality of members of a social networking service, the plurality of attribute values including member profile information; and inferring one or more attribute values regarding a particular member in the plurality of members based upon the collected plurality of attribute values and a plurality of collected attribute values of the particular member.

### Example 2

The method of example 1, wherein inferring one or more attribute values regarding a particular member comprises: calculating at least two probability association matrices for at least two different particular attributes of the plurality of attributes, each probability association matrix describing a probability for each particular attribute value of the particular attribute that a member associated with that particular attribute value would be associated with each of a plurality of attribute values of another attribute; calculating a plurality of specific probability association matrices for each particular one of the plurality of attribute values collected for the particular member, each specific probability association matrix describing a probability that given the particular attribute value that a member would be associated with each of a plurality of attribute values associated with a target attribute; and generating a combined probability association matrix for the particular member based upon combining the plurality of specific probability association matrices.

### Example 3

The method of example 2, wherein one of the at least two different particular attributes of the plurality of attributes used in the probability association matrices is a skill attribute and the probability association matrix describes a probability for each particular skill that a member associated with that particular skill would be associated with a different skill.

### Example 4

The method of any one of examples 2-3, wherein combining the probability association matrix includes: weighting a first specific probability association matrix of the plurality of specific probability association matrices with a first value; and weighting a second specific probability association matrix of the plurality of specific probability association matrices with a second value, the first and the second values being different values.

### Example 5

The method of any one of examples 2-4, wherein inferring one or more attribute values regarding a particular member comprises inferring one or more attribute values based upon the combined probability association matrices.

### Example 6

The method of any one of examples 2-5, wherein inferring one or more attribute values regarding a particular member comprises normalizing the combined probability association matrix based upon the total number of members with a particular value for the target attribute.

### Example 7

The method of any one of examples 1-6, comprising using the inferred one or more one or more attribute values in a search function.

### Example 8

The method of any one of examples 1-7, comprising using the inferred one or more one or more attribute values to suggest one or more skills for addition to the particular member's profile.

### Example 9

The method of any one of examples 1-8, comprising using the inferred one or more one or more attribute values to suggest one or more profile attribute values for addition to the particular member's profile.

### Example 10

The method of any one of examples 1-9, comprising using the inferred one or more one or more attribute values to select an advertisement for a plurality of advertisements, the selected advertisement being associated with the inferred one or more attribute values.

### Example 11

Disclosed in some examples is a system for inferring one or more attribute values of a member of a social networking service, the system comprising: a content server module configured to collect a plurality of attribute values associated with a plurality of attributes of a plurality of members of a social networking service, the plurality of attribute values including member profile information; and an inference generation module configured to infer one or more attribute values regarding a particular member in the plurality of members based upon the collected plurality of attribute values and a plurality of collected attribute values of the particular member.

### Example 12

The system of example 11, comprising a probability calculator module which is configured to: calculating at least two probability association matrices for at least two different particular attributes of the plurality of attributes, each probability association matrix describing a probability for each particular attribute value of the particular attribute that a member associated with that particular attribute value would be associated with each of a plurality of attribute values of another attribute; calculating a plurality of specific probability association matrices for each particular one of the plurality of attribute values collected for the particular member, each specific probability association matrix describing a probability that given the particular attribute value that a member would be associated with each of a plurality of attribute values associated with a target attribute; and generating a combined probability association matrix for the particular member based upon combining the plurality of specific probability association matrices; the inference generator module is configured to utilize the combined probability association matrix to infer the one or more attribute values.

### Example 13

The system of example 12, wherein one of the at least two different particular attributes of the plurality of attributes used in the probability association matrices is a skill attribute and the probability association matrix describes a probability for each particular skill that a member associated with that particular skill would be associated with a different skill.

### Example 14

The system of any one of examples 12-13, wherein the probability calculator module is configured to combine the probability association matrix by at least: weighting a first specific probability association matrix of the plurality of specific probability association matrices with a first value; and weighting a second specific probability association matrix of the plurality of specific probability association matrices with a second value, the first and the second values being different values.

### Example 15

The system of any one of examples 12-14, wherein the inference generation module is configured to infer one or more attribute values regarding a particular member by at least: inferring one or more attribute values based upon the combined probability association matrices based on a threshold value.

### Example 16

The system of any one of examples 12-15, wherein the probability calculator module is configured to combine the probability association matrix by at least: normalizing the combined probability association matrix based upon the total number of members with a particular value for the target attribute.

### Example 17

The system of any one of examples 11-16, wherein the content server module is configured to use the inferred one or more one or more attribute values in a search function.

### Example 18

The system of any one of examples 11-17, wherein the content server module is configured to use the inferred one or more one or more attribute values to suggest one or more skills for addition to the particular member's profile.

### Example 19

The system of any one of examples 11-18, wherein the content server module is configured to use the inferred one or more one or more attribute values to suggest one or more profile attribute values for addition to the particular member's profile.

### Example 20

The system of any one of examples 11-19, wherein the content server module is configured to use the inferred one or more one or more attribute values to select an advertisement for a plurality of advertisements which is associated with the inferred one or more attribute values.

### Example 21

Disclosed in some examples is a machine-readable storage medium including instructions which when performed by a machine, causes the machine to perform the operations comprising: collecting a plurality of attribute values associated with a plurality of attributes of a plurality of members of a social networking service, the plurality of attribute values including member profile information; and inferring one or more attribute values regarding a particular member in the plurality of members based upon the collected plurality of attribute values and a plurality of collected attribute values of the particular member.

### Example 22

The machine-readable medium of example 21, wherein the instructions for inferring one or more attribute values regarding a particular member comprises instructions which when performed by the machine causes the machine to perform operations comprising: calculating at least two probability association matrices for at least two different particular attributes of the plurality of attributes, each probability association matrix describing a probability for each particular attribute value of the particular attribute that a member associated with that particular attribute value would be associated with each of a plurality of attribute values of another attribute; calculating a plurality of specific probability association matrices for each particular one of the plurality of attribute values collected for the particular member, each specific probability association matrix describing a probability that given the particular attribute value that a member would be associated with each of a plurality of attribute values associated with a target attribute; and generating a combined probability association matrix for the particular member based upon combining the plurality of specific probability association matrices.

### Example 23

The machine-readable medium of example 22, wherein one of the at least two different particular attributes of the plurality of attributes used in the probability association matrices is a skill attribute and the probability association matrix describes a probability for each particular skill that a member associated with that particular skill would be associated with a different skill.

### Example 24

The machine-readable medium of any one of examples 22-23, wherein the instructions for combining the probability association matrix includes instructions which when performed by the machine, causes the machine to perform operations comprising: weighting a first specific probability association matrix of the plurality of specific probability association matrices with a first value; and weighting a second specific probability association matrix of the plurality of specific probability association matrices with a second value, the first and the second values being different values.

### Example 25

The machine-readable medium of any one of examples 22-24, wherein the instructions for inferring one or more attribute values regarding a particular member comprises instructions, which when performed by the machine, causes the machine to perform the operations comprising inferring one or more attribute values based upon the combined probability association matrices.

### Example 26

The machine-readable medium of any one of examples 22-25, wherein the instructions for inferring one or more attribute values regarding a particular member comprises instructions, which when performed by the machine, causes the machine to perform the operations comprising normalizing the combined probability association matrix based upon the total number of members with a particular value for the target attribute.

### Example 27

The machine-readable medium of any one of examples 21-26, wherein the instructions include instructions which when performed by the machine causes the machine to perform the operations comprising using the inferred one or more one or more attribute values in a search function.

### Example 28

The machine-readable medium of any one of examples 21-27, wherein the instructions include instructions which when performed by the machine causes the machine to perform the operations comprising suggesting one or more skills for addition to the particular member's profile based on the inferred one or more attribute values.

### Example 29

The machine-readable medium of any one of examples 21-28, wherein the instructions include instructions which when performed by the machine causes the machine to perform the operations comprising suggesting one or more profile attribute values for addition to the particular member's profile based on the inferred one or more attribute values.

### Example 30

The machine-readable medium of any one of examples 21-29, wherein the instructions include instructions which when performed by the machine causes the machine to perform the operations comprising: selecting an advertisement for a plurality of advertisements which is associated with the inferred one or more attribute values.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” and the like are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method of inferring one or more attribute values of a member of a social networking service, the method comprising:
collecting a plurality of attribute values associated with a plurality of attributes of a plurality of members of a social networking service, the plurality of attribute values including member profile information; and
inferring one or more attribute values regarding a particular member in the plurality of members based upon the collected plurality of attribute values and a plurality of collected attribute values of the particular member.

2. The method of claim 1, wherein inferring one or more attribute values regarding a particular member comprises:
calculating at least two probability association matrices for at least two different particular attributes of the plurality of attributes, each probability association matrix describing a probability for each particular attribute value of the particular attribute that a member associated with that particular attribute value would be associated with each of a plurality of attribute values of another attribute;
calculating a plurality of specific probability association matrices for each particular one of the plurality of attribute values collected for the particular member, each specific probability association matrix describing a probability that given the particular attribute value that a member would be associated with each of a plurality of attribute values associated with a target attribute; and
generating a combined probability association matrix for the particular member based upon combining the plurality of specific probability association matrices.

3. The method of claim 2, wherein one of the at least two different particular attributes of the plurality of attributes used in the probability association matrices is a skill attribute and the probability association matrix describes a probability for each particular skill that a member associated with that particular skill would be associated with a different skill.

4. The method of claim 2, wherein combining the probability association matrix includes:
weighting a first specific probability association matrix of the plurality of specific probability association matrices with a first value; and
weighting a second specific probability association matrix of the plurality of specific probability association matrices with a second value, the first and the second values being different values.

5. The method of claim 2, wherein inferring one or more attribute values regarding a particular member comprises inferring one or more attribute values based upon the combined probability association matrices.

6. The method of claim 2, wherein inferring one or more attribute values regarding a particular member comprises normalizing the combined probability association matrix based upon the total number of members with a particular value for the target attribute.

7. The method of claim 1, comprising using the inferred one or more one or more attribute values in a search function.

8. The method of claim 1, comprising using the inferred one or more one or more attribute values to suggest one or more skills for addition to the particular member's profile.

9. The method of claim 1, comprising using the inferred one or more one or more attribute values to suggest one or more profile attribute values for addition to the particular member's profile.

10. The method of claim 1, comprising using the inferred one or more one or more attribute values to select an advertisement for a plurality of advertisements, the selected advertisement being associated with the inferred one or more attribute values.

11. A system for inferring one or more attribute values of a member of a social networking service, the system comprising:
a content server module configured to collect a plurality of attribute values associated with a plurality of attributes of a plurality of members of a social networking service, the plurality of attribute values including member profile information; and
an inference generation module configured to infer one or more attribute values regarding a particular member in the plurality of members based upon the collected plurality of attribute values and a plurality of collected attribute values of the particular member.

12. The system of claim 11, comprising a probability calculator module which is configured to:
calculating at least two probability association matrices for at least two different particular attributes of the plurality of attributes, each probability association matrix describing a probability for each particular attribute value of the particular attribute that a member associated with that particular attribute value would be associated with each of a plurality of attribute values of another attribute;
calculating a plurality of specific probability association matrices for each particular one of the plurality of attribute values collected for the particular member, each specific probability association matrix describing a probability that given the particular attribute value that a member would be associated with each of a plurality of attribute values associated with a target attribute; and
generating a combined probability association matrix for the particular member based upon combining the plurality of specific probability association matrices;
the inference generator module is configured to utilize the combined probability association matrix to infer the one or more attribute values.

13. The system of claim 12, wherein one of the at least two different particular attributes of the plurality of attributes used in the probability association matrices is a skill attribute and the probability association matrix describes a probability for each particular skill that a member associated with that particular skill would be associated with a different skill.

14. The system of claim 12, wherein the probability calculator module is configured to combine the probability association matrix by at least:
weighting a first specific probability association matrix of the plurality of specific probability association matrices with a first value; and
weighting a second specific probability association matrix of the plurality of specific probability association matrices with a second value, the first and the second values being different values.

15. The system of claim 12, wherein the inference generation module is configured to infer one or more attribute values regarding a particular member by at least:
inferring one or more attribute values based upon the combined probability association matrices based on a threshold value.

16. The system of claim 12, wherein the probability calculator module is configured to combine the probability association matrix by at least:
normalizing the combined probability association matrix based upon the total number of members with a particular value for the target attribute.

17. The system of claim 11, wherein the content server module is configured to use the inferred one or more one or more attribute values in a search function.

18. The system of claim 11, wherein the content server module is configured to use the inferred one or more one or more attribute values to suggest one or more skills for addition to the particular member's profile.

19. The method of claim 11, wherein the content server module is configured to use the inferred one or more one or more attribute values to suggest one or more profile attribute values for addition to the particular member's profile.

20. The method of claim 11, wherein the content server module is configured to use the inferred one or more one or more attribute values to select an advertisement for a plurality of advertisements which is associated with the inferred one or more attribute values.

21. A machine-readable storage medium including instructions which when performed by a machine, causes the machine to perform the operations comprising:
collecting a plurality of attribute values associated with a plurality of attributes of a plurality of members of a social networking service, the plurality of attribute values including member profile information; and
inferring one or more attribute values regarding a particular member in the plurality of members based upon the collected plurality of attribute values and a plurality of collected attribute values of the particular member.

22. The machine-readable medium of claim 21, wherein the instructions for inferring one or more attribute values regarding a particular member comprises instructions which when performed by the machine causes the machine to perform operations comprising:
calculating at least two probability association matrices for at least two different particular attributes of the plurality of attributes, each probability association matrix describing a probability for each particular attribute value of the particular attribute that a member associated with that particular attribute value would be associated with each of a plurality of attribute values of another attribute;
calculating a plurality of specific probability association matrices for each particular one of the plurality of attribute values collected for the particular member, each specific probability association matrix describing a probability that given the particular attribute value that a member would be associated with each of a plurality of attribute values associated with a target attribute; and
generating a combined probability association matrix for the particular member based upon combining the plurality of specific probability association matrices.

23. The machine-readable medium of claim 22, wherein one of the at least two different particular attributes of the plurality of attributes used in the probability association matrices is a skill attribute and the probability association matrix describes a probability for each particular skill that a member associated with that particular skill would be associated with a different skill.

24. The machine-readable medium of claim 22, wherein the instructions for combining the probability association matrix includes instructions which when performed by the machine, causes the machine to perform operations comprising:
weighting a first specific probability association matrix of the plurality of specific probability association matrices with a first value; and
weighting a second specific probability association matrix of the plurality of specific probability association matrices with a second value, the first and the second values being different values.

25. The machine-readable medium of claim 22, wherein the instructions for inferring one or more attribute values regarding a particular member comprises instructions, which when performed by the machine, causes the machine to perform the operations comprising inferring one or more attribute values based upon the combined probability association matrices.

26. The machine-readable medium of claim 22, the instructions for inferring one or more attribute values regarding a particular member comprises instructions, which when performed by the machine, causes the machine to perform the operations comprising normalizing the combined probability association matrix based upon the total number of members with a particular value for the target attribute.

27. The machine-readable medium of claim 21, wherein the instructions include instructions which when performed by the machine causes the machine to perform the operations comprising using the inferred one or more one or more attribute values in a search function.

28. The machine-readable medium of claim 21, wherein the instructions include instructions which when performed by the machine causes the machine to perform the operations comprising suggesting one or more skills for addition to the particular member's profile based on the inferred one or more attribute values.

29. The machine-readable medium of claim 21, wherein the instructions include instructions which when performed by the machine causes the machine to perform the operations comprising suggesting one or more profile attribute values for addition to the particular member's profile based on the inferred one or more attribute values.

30. The machine-readable medium of claim 21, wherein the instructions include instructions which when performed by the machine causes the machine to perform the operations comprising: selecting an advertisement for a plurality of advertisements which is associated with the inferred one or more attribute values.
